(19) United States
(12) Patent Application Publication
(10) Pub. No.: US 2021/0304276 A1
(43) Pub. Date: Sep. 30, 2021

(54) MOBILE TRADING APPLICATION

(71) Applicant: buydo LLC, Sarasota, FL (US)

(72) Inventor: Tokhir Tokhtabaev, Bradenton, FL (US)

(21) Appl. No.: 17/217,713

(22) Filed: Mar. 30, 2021

Related U.S. Application Data
(60) Provisional application No. 63/001,649, filed on Mar. 30, 2020.

(51) Int. Cl. G06Q 30/06; G06Q 10/08; G06Q 20/20; G06Q 20/12; G06Q 20/08; G06F 16/27; H04N 7/14

(52) U.S. Cl. CPC G06Q 30/0617; G06Q 10/087; G06Q 30/0633; G06Q 20/208; G06Q 40/02; G06Q 20/085; G06F 16/27; H04N 7/147; G06Q 20/12

(57) ABSTRACT

A software application is compatible with an online trading platform having a product available for purchase. The software application is configured to communicate data regarding the product between the software application and the online trading platform and to establish a video conferencing session between a customer seeking to purchase the product and one of the seller of the product or an agent representing the seller of the product upon a request by the customer. The video conferencing session may include visualization of the product to be purchased and/or discussion of the product to be purchased.

### CROSS-REFERENCE TO RELATED APPLICATION

This patent application claims priority to U.S. Provisional Patent Application Ser. No. 63/001,649, filed on Mar. 30, 2020, the entire disclosure of which is hereby incorporated herein by reference.

### FIELD

The present invention relates generally to a method of trading, and more particularly, to a method of real-time communication between a seller and a customer through a mobile application including selection options presented on a screen of the seller and the customer.

### BACKGROUND OF THE INVENTION

As access to smartphones and tablets become more available across the world, mobile applications utilizing the functionality of the smartphone are regularly innovated and improved upon. The mobile applications are created to influence most aspects of life from recording a person's caloric intake to monitoring the speed of travel of the person. Another area that mobile applications have influenced is that of online shopping.

The popularity of online shopping has made online shopping a preferred method of shopping by many customers around the world. Online shopping provides customers with more access to shopping options that are otherwise not locally based within the customer's geographic location. Online shopping also provides customers with the ease and comfort of shopping from wherever they deem most convenient, rather than travelling to a “brick-and-mortar” establishment to purchase the same items that can be delivered to their doorstep. However, there remains a level of uncertainty in shopping online such as not being able to view the actual product being purchased, rather than a cataloged image of the product (which is commonly what is offered to the customer). To overcome this, customers commonly travel to brick-and-mortar establishments to treat the brick-and-mortar establishments as showrooms to test products and then make their purchases online. Thus, there is a need to be able to provide a mobile trading application that would provide the customer with the ability to view the product they may be interested in purchasing before any purchase is finalized.

### SUMMARY OF THE INVENTION

In concordance and agreement with the present invention, a new mobile trading application providing a customer with the ability to view a product they may be interested in purchasing before any purchase is finalized has surprisingly been discovered.

According to an embodiment of the present invention, a software application for use with an online trading platform having a product available for purchase is disclosed. The software application is configured to communicate data regarding the product between the software application and the online trading platform and to establish a video conferencing session between a customer seeking to purchase the product and one of the seller of the product or an agent representing the seller of the product.

According to further aspects of the invention, the software application may be configured to send a video conferencing request to the seller in response to a selection by the customer. The software application may be configured to reroute the video conferencing request to the agent in response to a selection by the seller. The software application may be configured to allow the seller to select the agent from a list of potential agents. The software application may be associated with a database, and the software application may be configured to synchronize the data regarding the product between the database and the online trading platform. The synchronizing of the data may include converting at least one file to a compatible file type. The software application may be configured to place the product within a virtual cart in response to an action taken by the seller. The action taken by the seller may include scanning a machine readable optical code associated with the product. The software application may alternatively be configured to place the product within a virtual cart in response to the agent entering a code associated with the product. The software application may be configured to communicate the code from the seller to the agent. The software application may be in communication with a payment system accessible by the customer, wherein the payment system initiates payment for the product by the customer. The software application may be configured to allocate a fee to the agent when the video conferencing session occurs between the customer and the agent and the product is purchased by the customer. The software application may be configured to place a hold on the product for a preselected period of time in response to the product being placed in a virtual cart, wherein the hold includes the product no longer being available for purchase during the preselected period of time. The software application may be configured to allow any of the customer, the seller, or the agent to place the product in the virtual cart during a video conferencing session. The software application may be configured for operation on a smart device. The smart device may include a video streaming feature.

A method of operating a software application is also disclosed. The method comprises the steps of sending a request for a video conferencing session regarding a product available for purchase through an online trading platform, wherein the request is initiated by a customer; and conducting the video conferencing session regarding the product between the customer and one of a seller of the product or an agent representing the seller of the product.

According to further aspects of the method according to the present invention, the method may further include a step of placing the product in a virtual cart during the video conferencing session. The software application may be configured to reroute the request for the video conferencing session to the agent in response to a selection by the seller. The method may also include a step of synchronizing data regarding the product between a database in communication with the software application and the online trading platform.

### BRIEF DESCRIPTION OF THE DRAWINGS

The above-mentioned, and other features and objects of the inventions, and the manner of attaining them will become more apparent and the invention itself will be better understood by reference to the following description of an embodiment of the invention taken in conjunction with the accompanying drawings, wherein:

FIG. 1 schematically demonstrates a streaming trading system having a streaming trading software application according to an embodiment of the present invention;

FIG. 2 schematically demonstrates an application workflow chart of the streaming trading software application according to FIG. 1;

FIG. 3 is an elevational view showing a display screen of a smart device of a customer during a video conferencing session between the customer and a seller;

FIG. 4 is an elevational view showing the display screen of the smart device of the customer when an “add to cart” page is displayed thereon following the selection of a button shown in FIG. 3;

FIG. 5 is an elevational view showing the display screen of the smart device of the customer when a “buy product” page is displayed thereon following the selection of a button shown in FIG. 3;

FIG. 6 is an elevational view showing a display screen of a smart device of a seller during a video conferencing session between the customer and a seller;

FIG. 7 is an elevational view showing the display screen of the smart device of the seller when an “add to cart” page is displayed thereon following the selection of a button shown in FIG. 6;

FIG. 8 is an elevational view showing the display screen of the smart device of the seller when a “transfer to an agent” page is displayed thereon following the selection of a button shown in FIG. 6; and

FIG. 9 is an elevational view showing the display screen of the smart device of the seller when a “scan code” page is displayed thereon following the selection of a button shown in FIG. 6.

### WRITTEN DESCRIPTION OF THE INVENTION

The following detailed description and appended drawings describe and illustrate various exemplary embodiments of the invention. The description and drawings serve to enable one skilled in the art to make, and use the invention, and are not intended to limit the scope of the invention in any manner. With respect to the methods disclosed, the steps presented are exemplary in nature, and thus, the order of the steps is not necessary or critical.

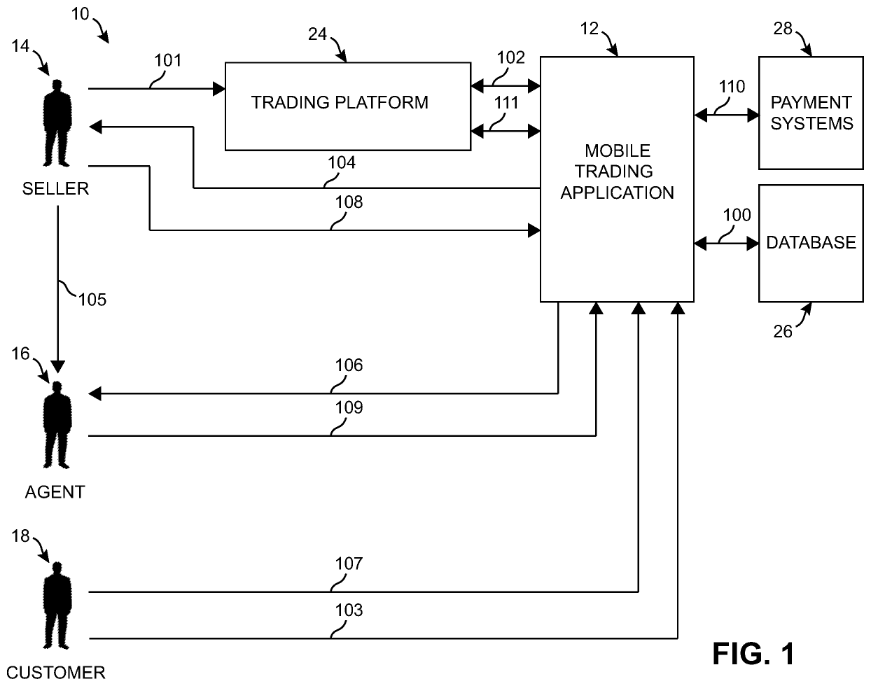

FIG. 1 illustrates a streaming trading system 10 according to an embodiment of the present invention. The streaming trading system 10 includes the use of a streaming trading application 12 according to an embodiment of the present invention. The streaming trading system 10 as depicted in FIG. 1 illustrates the possible relationships that may be facilitated between a seller 14, an agent 16, and a customer 18 during use of the streaming trading application 12. As explained hereinafter, the use of an agent 16 is optional during operation of the streaming trading application 12, as the use of the agent 16 is dependent on a selection made by the seller 14 during use of the streaming trading application 12. The streaming trading application 12 beneficially facilitates the ability for the customer 18 to visually review and discuss certain goods (or services) offered on online trading and sales platforms prior to purchase thereof, wherein the seller 14 or the agent 16 is responsible for showing and/or discussing the goods or services following an inquiry from the customer 18 via the streaming trading application 12.

The seller 14 initiates the streaming trading system 10 by installing the streaming trading application 12 upon a compliant smart device 20. As used herein, a smart device 20 refers to any electronic device having a display screen 21, a user interface, and at least one communication device or feature configured for receiving and sending data between the smart device 20 and an external device or network, such as the internet. The at least one communication device or feature may be configured to perform wired data transfer or wireless data transfer, as desired. The display screen 21 may be a touch screen that acts as the user interface for interacting with the smart device 20, as shown throughout the accompanying figures. The smart device 20 may further include audiovisual devices or features such as a camera, a speaker, a microphone, or the like, or may include ports for directly or wirelessly connecting external devices such as the camera, speaker, or microphone. The smart device 20 is configured to store the streaming trading application 12 to a memory thereof and to execute the streaming trading application 12 via a processor thereof upon a request by the corresponding seller 14, agent 16, or customer 18 instantaneously operating the streaming trading application 12.

The streaming trading application 12 is a software application configured for execution on a compatible one of the smart devices 20. In some circumstances, the streaming trading application 12 may alternatively be executed via a web browser or similar application operating on the corresponding smart device 20, as desired, wherein the same processes are carried out as described with reference to the use of the independent application. However, the streaming trading application 12 is described hereinafter as being executed as an independently provided software application stored to and running on one of the smart devices 20.

The smart device 20 is configured to allow the streaming trading application 12 access to the previously mentioned audiovisual devices or features thereof so that the streaming trading application 12 can perform the necessary audio and/or visual functions as described hereinafter. The smart device 20 may be a smart phone, a smart tablet, a smart watch, or the like, or may be a laptop or other computing device having the necessary devices integrated therein, connected thereto, or otherwise associated therewith for carrying out the described audio and/or visual functions of the streaming trading application 12 (camera, microphone, speaker, etc.). Any electronic device capable of carrying out the methods described hereinafter may be utilized as one of the representative smart devices 20 without departing from the scope of the present invention.

It assumed hereinafter that each of the seller 14, the agent 16, and the customer 18 is associated with an independent smart device 20, wherein each of the smart devices 20 is able to perform each of the associated functions described hereinafter with respect to each possible participant 14, 16, 18. With reference to FIG. 1, each action shown as being taken by any one of the seller 14, the agent 16, or the customer 18 is assumed to be performed using a corresponding one of the smart devices 20, wherein the corresponding one of the smart devices 20 initiates the necessary communications between the streaming trading application 12 and any necessary external components or networks.

The streaming trading application 12 is configured to communicate with a database 26 and at least one payment system 28. The database 26 may refer to any data storage device or system of networked data storage devices, as desired, that are associated with and accessible to the streaming trading application 12. The database 26 may be remotely located and accessible to each of the associated smart devices 20 via internet communication. The streaming trading application 12 is configured to communicate any relevant information to the database 26 or to receive any relevant information from the database 26 via the corresponding smart device 20, as necessary. Communications between the database 26 and the streaming trading application 12 are indicated at line 100 in FIG. 1.

Each of the at least one payment systems 28 may be any system configured for making an online payment or monetary transfer such as a cooperating credit/debit card service provider, banking establishment, cryptocurrency platform, or the like. For example, the streaming trading application 12 may be in communication with a cooperating credit card service provider for initiating online payments through the streaming trading application 12 via an associated credit card, wherein the streaming trading application 12 communicates with the payment system 28 corresponding to the associated credit card service provider when attempting to complete a transaction using the associated credit card.

Upon the installation of the streaming trading application 12, the seller 14 is able to upload a desired product 22 to an online store 24 or online trading platform 24, hereinafter referred to as the trading platform 24. This step is designated at line 101 in FIG. 1. The trading platform 24 may be accessed using one of the smart devices 20 via an internet browser thereof or a software application directly associated with the corresponding trading platform 24. The trading platform 24 is representative of any online trading or sales platform where goods (or services) can be browsed and purchased by the customer 18 following the posting of the goods by the seller 14. Representative trading platforms 24 may include Amazon®, Etsy®, or EBay®, as non-limiting examples.

The streaming trading application 12 is shown and described hereinafter as communicating with the trading platform 24, the database 26, each of the at least one payment systems 28, and one or more of the smart devices 20 operating other instances of the streaming trading application 12. As used herein, the streaming trading application 12 communicating with another such external component 20, 24, 26, 28 refers to the streaming trading application 12 commanding the corresponding smart device 20 running the streaming trading application 12 to send signals to or receive signals from the corresponding external component 20, 24, 26, 28, whether directly or via one or more intervening components 20, 24, 26, 28. For example, the streaming trading application 12 running on one of the smart devices 20 may communicate with the trading platform 24 via the database 26, such as when the streaming trading application 12 sends a signal to the database 26, which in turn sends a signal to the trading platform 24 in response to the reception and analysis of the signal originating from the streaming trading application 12.

It is also conceivable that the streaming trading application 12 may include an integrated trading platform 24 accessible during use of the streaming trading application 12, wherein products can be browsed and purchased directly through the streaming trading application 12, rather than through an independent third party trading platform such as one of the exemplary trading platforms 24 mentioned hereinabove. Although either circumstance is within the scope of the present invention, the method according to the present invention is generally described hereinafter as occurring with respect to an independently provided third party trading platform 24 that communicates with and synchronizes with the streaming trading application 12. It should be apparent that the integration of the trading platform 24 into the streaming trading application 12 may remove the need to communicate data externally between the two applications 12, 24, but the remainder of the method according to the present invention remains substantially the same as it pertains to the interactions between the seller 14, the agent 16, and the customer 18.

The uploading of the desired product 22 may include the seller 14 selecting information regarding the associated good or service to be communicated to the customer 18 when accessible via the trading platform 24, such as representative photographs or other images, product specifications, shipping details, or pricing information, as non-limiting examples. Such information may be displayed or otherwise communicated to the customer 18 via the corresponding interface of the smart device 20 during browsing of the trading platform 24. The information associated with the uploading and posting of the associated product 22 may be dependent on the instantaneous trading platform 24 to which the product 22 is being posted for sale, as different trading platforms 24 may have different terms of service.

In some circumstances, the seller 14 may represent a retailer or manufacturer having many different products available for sale online on a particular trading platform 24, and each product may have a variable quantity of the product in stock and available for sale at one given time. In such circumstances, the seller 14 may utilize the trading platform 24 and/or the streaming trading application 12 to perform an inventory feature by uploading each product that is available online by the seller 14 to an account associated with the seller 14, wherein such an account tracks the goods that are offered for sale, the quantities of such goods in stock, and any other pertinent information, such as the location of such goods within the corresponding retail establishment or warehouse of the seller 14. Such an account may be hosted by the trading platform 24, the streaming trading application 12, or a combination of the two, wherein data may be communicated and synchronized between the streaming trading application 12 and the trading platform 24, as desired.

Once the product 22 has been uploaded to the trading platform 24, the streaming trading application 12 is configured to synchronize data regarding the product 22 between the trading platform 24 and the streaming trading application 12. This step is indicated at line 102 in FIG. 1. For example, any information regarding the product 22 that was provided to the trading platform 24 during the uploading of the product 22 may be communicated to the mobile trading application 12 and associated with the product 22. Alternatively, the information regarding the product 22 may initially be supplied to the streaming trading application 12 before being subsequently communicated to a cooperating trading platform 24 upon the synchronization of the data.

The synchronizing of the data may also include the conversion of the data to a different form, such as altering certain data to conform to the software-related requirements of the streaming trading application 12 and/or the trading platform 24, which may require the data regarding the product 22 being uploaded as a specific type of file for display to the customer 18. For example, the trading platform 24 may utilize a certain image file type for visual display while the streaming trading application 12 may utilize a different image file type for visual display, and the synchronization step may include the conversion of any non-compliant file types to a file type suitable for use with either the application 12 or the trading platform 24.

If the streaming trading application 12 is used as an inventory feature for multiple different products 22, the seller 14 may upload any data regarding each and every of the corresponding products 22, whether any one of the products 22 is in stock or out of stock relative to a physical location associated with the seller 14, such as a retail store or warehouse associated with the seller 14. The data associated with each of the products 22 as uploaded to the streaming trading application 12 may be communicated to and stored within the database 26. The database 26 may accordingly monitor the inventory of those products 22 available for sale via the streaming trading application 12 and/or the trading platform 24.

The manner in which the streaming trading application 12 is configured to synchronize with the trading platform 24 allows for the data regarding the product(s) 22 to be initially uploaded to either of the streaming trading application 12 or the trading platform 24, wherein the relevant data is subsequently passed on to the other of the streaming trading application 12 or the trading platform 24 during the synchronizing step. For example, the seller 14 may upload data regarding an entire catalogue of products 22 to a corresponding trading platform 24, wherein each of the corresponding products 22 is compatible for use with the streaming trading application 12. The seller 14 may then select for some or all of the products 22 associated with the catalogue stored to the trading platform 24 to be synchronized with the streaming trading application 12. Each of the synchronized products 22 may then be able to be interacted with using the streaming capabilities of the streaming trading application 12, as explained in greater detail hereinafter. As an alternative example, the data regarding a catalogue of products 22 may alternatively be initially uploaded and stored to the database 26 associated with the streaming trading application 12. In this circumstance, some or all of the catalogued products 22 are able to be selected for synchronization with one or more compatible trading platforms 24. Each synchronization step may include the data regarding the products 22 being converted to a form suitable for posting the product 22 for sale to the corresponding trading platform 24, such as the previously mentioned images, specifications, pricing information, and the like associated with the product 22 being converted for display in a manner typical to the corresponding trading platform 24.

Each of the trading platforms 24 compatible for use with the streaming trading application 12 may function in typical fashion wherein the customer 18 searches or otherwise browses for products 22 that the customer 18 may desire to purchase, wherein the searching or browsing process may include information regarding each of the products 22 displayed for viewing by the customer 18. Each listing of one of the products 22 may include an icon or other interactive feature that may be interacted with by the customer 18 to initiate a video conference utilizing the streaming trading application 12. For example, such an icon or other interactive feature may form a portion of the display screen of the smart device 20 adjacent other icons or interactive features associated with placing the product 22 within a “virtual cart” or with immediately purchasing the product 22 based on preselected transaction settings, as non-limiting examples. The selection of the video conferencing feature by the customer 18 is indicated by line 103 in FIG. 1.

The selection of the video conferencing feature by the customer 18 results in the streaming trading application 12 communicating a video conferencing request to the seller 14. This step is indicated at line 104 in FIG. 1. Specifically, the streaming trading application 12 associated with the smart device 20 of the customer 18 sends a video conferencing request to the streaming trading application 12 associated with the smart device 20 of the seller 14 in an attempt to establish a streaming audiovisual connection therebetween. Each of the smart devices 20 may utilize the corresponding audiovisual devices or features thereof for establishing such a streaming audiovisual connection, such as any associated cameras, speakers, microphones, or the like. Although described as a video conference having a video feed and associated audio, it should be understood that only audio or only visual content may be communicated using the streaming trading application 12 while remaining within the scope of the present invention.

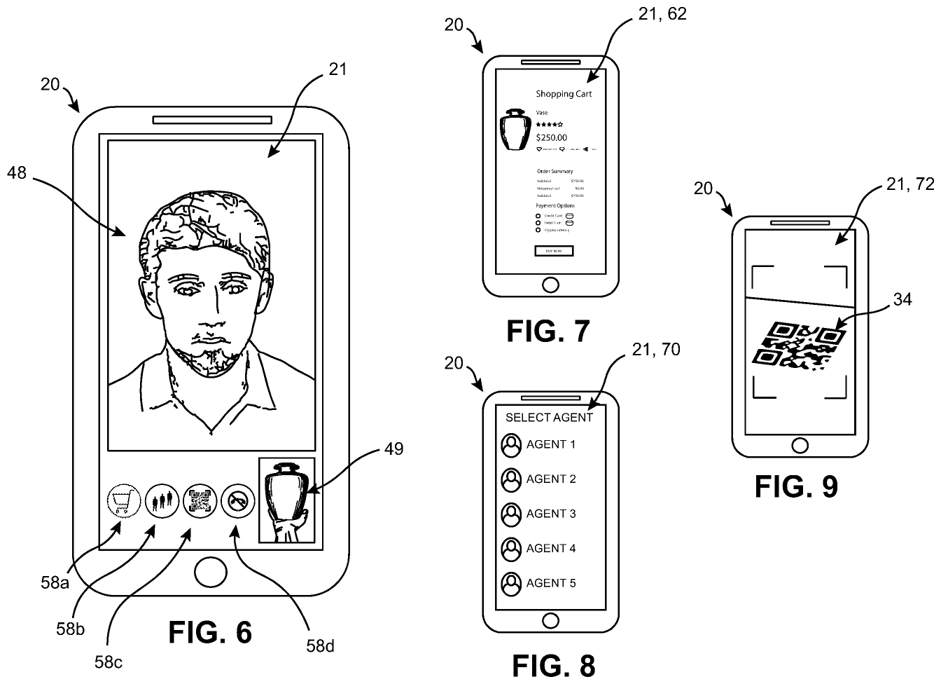

As indicated at line 105 in FIG. 1, the seller 14 may select to route the video conferencing request to the agent 16, so that the agent 16 may answer the video conferencing request on behalf of the seller 14. The rerouting of the video conferencing request to the agent 16 may include the streaming trading application 12 associated with the customer 18 resending the video conferencing request directly to the agent 16, as indicated by line 106 in FIG. 1. Alternatively, the seller 14 may allow for the agent 16 to receive the video conferencing request directly from the customer 18 via the streaming trading application 12. For example, the seller 14 may preselect that all video conferencing requests be immediately sent to the agent 16 initially, rather than being sent to the seller 14 for subsequent rerouting to the agent 16. The direct sending of the video conferencing request to the agent 16 is similarly represented by line 106 in FIG. 6. The seller 14 may also be provided a code that the seller 14 may supply to the agent 16, allowing the agent 16 to complete a purchase with the customer 18 on behalf of the seller 14, as explained hereinafter. The transfer of this code may also be represented by line 105 in FIG. 1. It is understood that the agent 16 may answer any type of call on behalf of the seller 14, however.

The video conferencing feature of the streaming trading application 12 may be initiated by the customer 18 when the customer 18 would like to review the corresponding product 22 in a manner more consistent with the sales process that occurs in a corresponding brick-and-mortar establishment. Specifically, the video conferencing feature allows for the seller 14 or the agent 16, depending on which handles the request, to have face-to-face communication with the customer 18 through the display screens 21 of the associated smart devices 20. The video conferencing feature also allow for the seller 14 or the agent 16 to reposition or manipulate the product 22 in ways that reveal characteristics of the product 22 that may not be apparent via the information normally communicated through the corresponding trading platform 24. For example, the fit and appearance of products such as clothing may be more easily ascertained when reviewed relative to the seller 14 or the agent 16. The video conferencing feature also allows for the seller 14 or the agent 16 to show the specific product 22 being purchased by the customer 18, as opposed to a representative example of the product 22, when quality assurances or the like are required. Alternatively, the video conferencing feature may be carried out with respect to a representative version of the product 22 for presentation purposes, such as utilizing a representative electronic device to show the capabilities of the product 22 being purchased. However, it is understood that the seller 14 or the agent 16 may answer any type of call for the purpose of answering any type of inquiry regarding the selected product 22.

During the video conferencing session, the customer 18 may choose to purchase the product 22 being discussed via the streaming trading application 12. The customer 18 may make a selection indicating that the customer 18 would like to place the product 22 being discussed within a virtual cart 32. The virtual cart 32 refers to a hold being placed on the product 22 while the customer 18 determines various payment or shipping options for finalizing the transaction, as is typical of many trading platforms 24 such as those representative trading platforms 24 listed herein. The selection of the product 22 by the customer 18 for placement within the virtual cart 32 is indicated at line 107 in FIG. 1.

The streaming trading application 12 also allows for either of the seller 14 or the associated agent 16 to make the selection for placing the product 22 being discussed within the virtual shopping cart 32 on behalf of the customer 18, depending on which of the seller 14 or the agent 16 is communicating with the customer 18. The seller 14 making the selection to place the discussed product 22 within the virtual cart 32 is indicated at line 108 in FIG. 1, whereas the agent 16 making the selection to place the discussed product 22 within the virtual cart 32 is indicated at line 109 in FIG. 1.

Once the product 22 is in the virtual cart 32, the customer 18 may complete the payment for the product 22 via a payment feature of the streaming trading application 12. Specifically, the streaming trading application 12 communicates with a corresponding one of the payment systems 28 as selected by the customer 18 to establish, approve, and carry out a desired transaction. This process is indicated at line 110 in FIG. 1. For example, the customer 18 may select a credit card as payment, and the streaming trading application 12 may communicate with the credit card service provider to complete the transaction as is typical of online trading platforms.

The purchase of the product 22 may then be communicated back to the trading platform 24 to initiate payment settlements between the streaming trading application 12 and the corresponding trading platform 24. This step is indicated at line 111 in FIG. 1. The payment settlement process may be associated with the process of determining how to distribute the payment made by the customer 18 between the seller 14 and the agent 16, or may be associated with synchronizing the payment history data between the streaming trading application 12 and the trading platform 24, as desired.

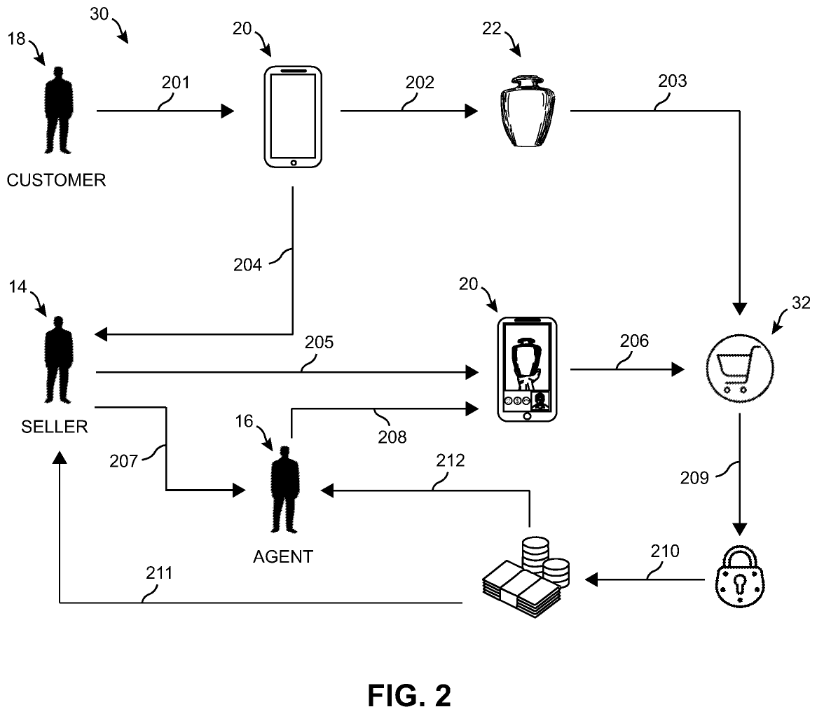

FIG. 2 demonstrates an application workflow 30 of the streaming trading application 12 wherein the relationship between the customer 18, the seller 14, and the agent 16 is further disclosed. The customer 18 initiates the application workflow 30 by engaging with the streaming trading application 12 using a corresponding smart device 20 as indicated at line 201 in FIG. 2. Upon opening the mobile trading application 12, the customer 18 may browse a selection of products 22 by any number of sellers 14 on any number of trading platforms 24. Alternatively, the customer 18 may access one of the trading platforms 24 compatible with the streaming trading application 12 via the smart device 20. In either circumstance, the customer 18 is provided with products 22 to browse that can be purchased, and the customer 18 is provided with the option to select to initiate a video conferencing session to discuss an associated one of the products 22. Among the available products 22, the customer 18 may select one product 22 that the customer 18 desires to purchase or for which the customer 18 would like to have access to additional information. The selection of a specific product 22 is indicated by line 202 in FIG. 2. In the representative example used hereinafter, the product 22 is shown as a vase. However, the product 22 may be any product (or service), as desired.

The customer 18 may select the product 22 the customer 18 is interested in and place the product 22 directly in the virtual shopping cart 32 to ultimately purchase the product 22 placed therein in the absence of any further discussion or display of the product 22 via a video conferencing session. Such a selection is indicated by line 203 in FIG. 2.

In the instance wherein the customer 18 is interested in inquiring with regards to the specific product 22, the customer 18 is able to initiate the video conferencing session with the seller 14. It is understood that the seller 14 may answer any type of call, however. The request for a video conferencing session by the customer 18 is indicated by line 204 in FIG. 2.

If the customer 18 chooses to initiate the video conferencing session with the seller 14, the seller 14 may answer the video conferencing session to demonstrate the physical product 22 and answer any questions the customer 18 may have about the physical product 22. The acceptance of the video conferencing request by the seller 14 is indicated at line 205 in FIG. 2. If the customer 18 expresses interest in purchasing the physical product 22 while speaking to the seller 14 during the video conferencing session, the seller 14 may utilize the camera application of the associated smart device 20 to scan a machine readable optical code 34 such as a quick response (QR) code or a bar code. The machine readable optical code 34 may include information encoded therein that is associated with and unique to the specific product 22 being discussed. As such, only one physical product 22 is associated with a given machine readable optical code 34. Once the machine readable optical code 34 is scanned by the seller 14, the product 22 is placed in the virtual basket 32. The machine readable optical code 34 may be scanned to facilitate the placement of the product 22 into the virtual cart 32 by the seller 14 during the video conferencing session, as mentioned hereinabove. The placement of the product 22 into the virtual cart 32 is indicated by line 206 in FIG. 2.

Alternatively, the seller 14 may route the video conferencing request from the customer 18 to the agent 16, so that the agent 16 may answer the video conferencing request on behalf of the seller 14. The rerouting of the video conferencing request to the agent 16 is indicated at line 207 in FIG. 2, and the acceptance of the video conferencing request by the agent 16 is indicated at line 208. The customer 18 is able to express his or her interest in purchasing the physical product 22 while speaking to the agent 16 during the video conferencing session. In the instance wherein the customer 18 expresses their interest in purchasing the product 22 while speaking to the agent 16 during the video conferencing session, the agent 16 is given a code from the seller 14 that allows for the agent 16 to place the product 22 in the virtual basket 32. This code may act in the same manner as the previously described machine readable optical code 34, but can be entered manually rather than requiring the scanning of the code. The placement of the product 22 into the virtual cart 32 is once again indicated by line 206 in FIG. 2.

Whether the customer 18, the seller 14, or the agent 16 places the product 22 in the virtual cart 32, the product 22 is reserved within the virtual cart 32 for a given time period, effectively not allowing any other customer to purchase the product 22 when in the virtual cart 32. When the product 22 is reserved, the streaming trading application 12 indicates to other users that the product 22 is reserved. The reservation of the product 22 for a given period of time is represented by line 209 in FIG. 2. When the given time period has passed, the streaming trading application 12 indicates to other users that the product 22 is available again. If the customer 18 ultimately refuses to purchase the product 22 placed within the virtual cart 32, and removes the product 22 from their virtual cart 32, the streaming trading application 12 also indicates that the product 22 is available once again. The purchasing of the product 22 occurs with respect to the previously discussed payment systems 28. The purchase of the product 22 is indicated by line 210 in FIG. 2.

When the purchase is completed, the streaming trading application 12 will indicate that the product 22 has been sold. When the purchase of the product 22 is completed, payment for the product 22 is then received by the seller 14, as indicated by line 211 in FIG. 2. However, in the instance where the agent 16 was forwarded the video conferencing request from the seller 14, the agent 16 receives a commission fee from the payment the seller 14 receives if the customer 18 ultimately purchases the product 22. The transfer of this commission fee is represented by line 212 in FIG. 2. It is understood that the seller 14 may allow for the agent 16 to receive the video conferencing request directly from the customer 18, however.

FIGS. 3-5 are illustrative of representative graphics that may be presented on the display screen 21 of the customer 18 during a video conferencing session using the streaming trading application 12. The customer display screen 21 as shown in FIG. 3 appears when the customer 18 calls the seller 14. A video feed 38 of the seller 14 (or agent 16) fills a majority of the customer screen 21, which allows for the customer 18 to have a maximum viewpoint of the product 22 the customer 18 called the seller 14 to inquire about. It is understood that the video feed 38 of the seller 14 may fill any portion of the customer screen 21, however. A video feed 39 of the customer 18 fills a minimal portion of the customer screen 21, which allows for the customer 18 to view the video feed 39 that is being transmitted to the seller 14. It is understood that the video feed 39 of the customer 18 may fill any portion of the customer screen 21, however.

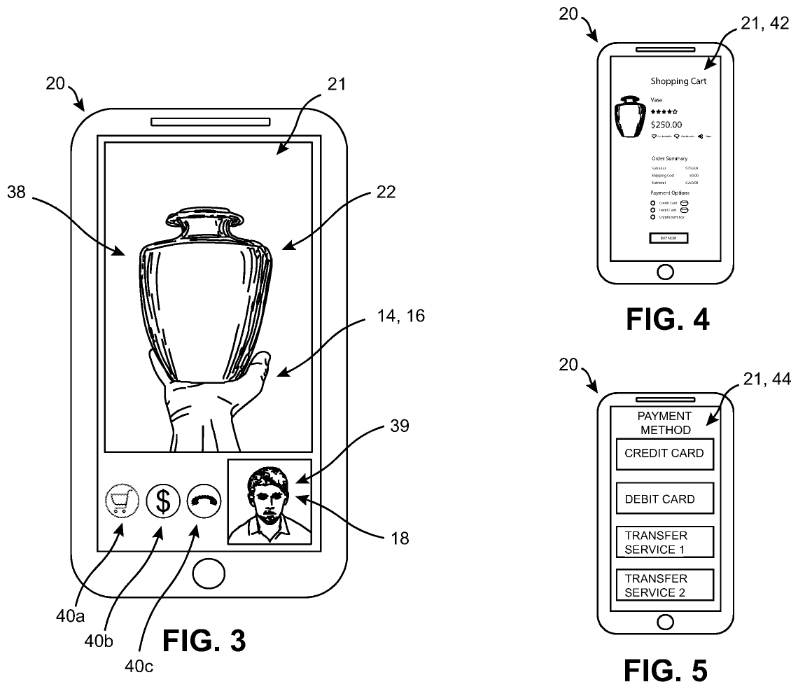

A plurality of buttons 40a, 40b, 40c is located on the bottom of the customer screen 21, under the video feed 38 of the seller 14. However, it is understood that the plurality of buttons 40a, 40b, 40c may be located anywhere on the customer screen 21. Each of the buttons 40a, 40b, 40c is representative of an interactive graphical area of the display screen 21 that may be selected by the user of the corresponding smart device 20, such as by a touch via a touch screen display. In the embodiment shown, the plurality of buttons 40a, 40b, 40c includes an “add to cart” button 40a, a “buy product” button 40b, and a “call end” button 40c. The customer 18 may select the “add to cart” button 40a to place the product 22 in the virtual cart 32. When the customer 18 selects the “add to cart” button 40a, the customer screen 21 transitions to an “add to cart” page 42, which is shown in FIG. 4. The “add to cart” page 42 displays a detailed description of the product 22, including but not limited to, a size of the product 22, an enlarged image of the product 22, and details and care of the product 22, for example. The “add to cart” page 42 allows for the seller 14 to place the product 22 in the virtual cart 32. The customer 18 may select the “buy product” button 40b to purchase the product 22. When the customer 18 selects the “buy product” button 40b, the customer screen 21 transitions to a “buy product” page 44. The “buy product” page 44 offers the customer 18 a variety of payment methods the customer 18 may select to complete the purchase of the product 22. The customer 18 may select the “call end” button 40c to end the video conferencing session with the seller 14 or the agent 16, depending on the circumstances. It is understood that any other button with any other functionality may be included in the plurality of buttons 40a, 40b, 40c, however.

FIGS. 6-9 are illustrative of representative graphics that may be presented on the display screen 21 of the seller 14 (or the agent 16) during a video conferencing session using the streaming trading application 12. The seller screen 21 appears when the customer 18 calls the seller 14. It is understood the seller screen 21 can also appear to the agent 16 if the agent 16 is involved in the transaction. A video feed 48 of the customer 18 fills a majority of the seller screen 21, which allows for the seller 14 to have a maximum viewpoint of the customer 18. It is understood that the video feed 48 of the customer 18 may fill any portion of the seller screen 21, however. A video feed 49 of the seller 14 fills a minimal portion of the seller screen 21, which allows for the seller 14 to view the video feed 49 that is being transmitted to the customer 18. It is understood that the video feed 49 of the seller 14 may fill any portion of the seller screen 21, however.

A plurality of buttons 58a, 58b, 58c, 58d is located on the bottom of the seller screen 21, under the video feed 48 of the customer 18. However, it is understood that the plurality of buttons 58a, 58b, 58c, 58d may be located anywhere on the seller screen 21. The plurality of buttons 58a, 58b, 58c, 58d includes an “add to cart” button 58a, a “transfer to agent” button 58b, a “scan code” button 58c, and a “call end” button 58d. The seller 14 may select the “add to cart” button 58a to place the product 22 in the virtual cart 32. When the seller 14 selects the “add to cart” button 58a, the seller screen 21 transitions to the “add to cart” page 62, as shown in FIG. 7. The “add to cart” page 62 displays a detailed description of the product 22, including but not limited to, a size of the product 22, an enlarged image of the product 22, and details and care of the product 22, for example. The “add to cart” page 62 allows for the seller 14 to place the product 22 in the virtual cart 32. The seller 14 may select the “transfer to an agent” button 58b to route the video conferencing request from the seller 14 to the agent 16. When the seller 14 selects the “transfer to an agent” button 58b, the seller screen 21 transitions to a “transfer to an agent” page 70, which is shown in FIG. 8. The “transfer to an agent” page 70 displays a list of agents 16 that the seller 14 may choose from to transfer the video conferencing request. The seller 14 may select the “scan code” button 58c to scan the machine readable optical code 34. When the seller 14 selects the “scan code” button 58c, the seller screen 21 transitions to a “scan code” page 72, which is shown in FIG. 9. The “scan code” page 72 provides the seller 14 with a capture screen that is able to read the machine readable optical code 34. The seller 14 may select the “call end” button 58d to end the video conferencing session with the customer 18. It is understood that any other button with any other functionality may be included in the selection of buttons, however. It is also understood that the seller screen 21 may similarly appear for the use of the agent 16 in the instance wherein the seller 14 routes the video conferencing request to the agent 16.

A streaming trading application 12 shown and described herein provides numerous benefits over traditional shopping methods. Particularly, the streaming trading application 12 enables the customer 18 to communicate directly with the seller 14 of the product 22, while directly viewing the physical product 22 via a video stream before purchasing the product 22. Allowing the customer 18 to view the physical product 22 before committing to purchasing the product 22 provides the customer 18 the confidence they would have if buying the product 22 in a physical store, rather than virtually.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A software application for use with an online trading platform having a product available for purchase, the software application configured to:
communicate data regarding the product between the software application and the online trading platform, and
establish a video conferencing session between a customer seeking to purchase the product and one of the seller of the product or an agent representing the seller of the product.

2. The software application of claim 1, wherein the software application is configured to send a video conferencing request to the seller in response to a selection by the customer.

3. The software application of claim 2, wherein the software application is configured to reroute the video conferencing request to the agent in response to a selection by the seller.

4. The software application of claim 3, wherein the software application is configured to allow the seller to select the agent from a list of potential agents.

5. The software application of claim 1, wherein the software application is associated with a database, and wherein the software application is configured to synchronize the data regarding the product between the database and the online trading platform.

6. The software application of claim 5, wherein the synchronizing of the data includes converting at least one file to a compatible file type.

7. The software application of claim 1, wherein the software application is configured to place the product within a virtual cart in response to an action taken by the seller.

8. The software application of claim 7, wherein the action taken by the seller includes scanning a machine readable optical code associated with the product.

9. The software application of claim 1, wherein the software application is configured to place the product within a virtual cart in response to the agent entering a code associated with the product.

10. The software application of claim 9, wherein software application is configured to communicate the code from the seller to the agent.

11. The software application of claim 1, wherein the software application is in communication with a payment system accessible by the customer, wherein the payment system initiates payment for the product by the customer.

12. The software application of claim 1, wherein the software application is configured to allocate a fee to the agent when the video conferencing session occurs between the customer and the agent and the product is purchased by the customer.

13. The software application of claim 1, wherein the software application is configured to place a hold on the product for a preselected period of time in response to the product being placed in a virtual cart, wherein the hold includes the product no longer being available for purchase during the preselected period of time.

14. The software application of claim 1, wherein the software application is configured to allow any of the customer, the seller, or the agent to place the product in the virtual cart during a video conferencing session.

15. The software application of claim 1, wherein the software application is configured for operation on a smart device.

16. The software application of claim 15, wherein the smart device includes a video streaming feature.

17. A method of operating a software application comprising the steps of:
sending a request for a video conferencing session regarding a product available for purchase through an online trading platform, wherein the request is initiated by a customer; and
conducting the video conferencing session regarding the product between the customer and one of a seller of the product or an agent representing the seller of the product.

18. The method of claim 17, further comprising a step of placing the product in a virtual cart during the video conferencing session.

19. The method of claim 17, wherein the software application is configured to reroute the request for the video conferencing session to the agent in response to a selection by the seller.

20. The method of claim 17, further comprising a step of synchronizing data regarding the product between a database in communication with the software application and the online trading platform.
